(19) United States
(12) Patent Application Publication
(10) Pub. No.: US 2020/0282435 A1
(43) Pub. Date: Sep. 10, 2020

(54) ULTRASONIC LENS CLEANING SYSTEMS AND METHODS

(71) Applicant: TEXAS INSTRUMENTS INCORPORATED, Dallas, TX (US)

(72) Inventors: DAVID PATRICK MAGEE, ALLEN, TX (US); JAMES KELLY GRIFFIN, GARLAND, TX (US)

(21) Appl. No.: 16/694,403

(22) Filed: Nov. 25, 2019

Related U.S. Application Data
(60) Provisional application No. 62/815,192, filed on Mar. 7, 2019.
(60) Provisional application No. 62/815,226, filed on Mar. 7, 2019.

(51) Int. Cl. B08B 7/02; G02B 27/00

(52) U.S. Cl. CPC B08B 7/028; G02B 27/0006

(57) ABSTRACT

This disclosure relates to systems and methods for ultrasonic lens cleaning. In an example, an ultrasonic lens cleaning system can be configured to apply sequences that include at least one driver signal adapted to drive a transducer adaptively coupled to a top cover. The transducer can be excited based on the sequences to vibrate the top cover to remove a contaminant from a surface of the top cover. The applying of the sequences can include applying a first sequence to the transducer based on a first set of sequence parameters, applying a second sequence to the transducer based on a second set of sequence parameters, and applying a third sequence to the transducer based on a third set of sequence parameters.

### RELATED APPLICATIONS

This application claims priority from U.S. Provisional Patent Application Ser. No. 62/815,192 and U.S. Provisional Patent Application Ser. No. 62/815,226, filed respectively on 7 Mar. 2019, both of which are incorporated herein their entirety.

### TECHNICAL FIELD

This disclosure relates to systems and methods for ultrasonic lens cleaning.

### BACKGROUND

Optical devices are often employed in remote locations for remote viewing. For example, in vehicle applications, cameras can be disposed at a rear of a vehicle to aid in backing up and alleviating a rear blind spot (e.g., an area around the vehicle that cannot be directly observed by the driver while at controls of the vehicle). Remote optical devices, such as backup cameras, often become contaminated, which causes clouding or obstruction in the optical lens, such that degraded images are generated. The degradation of the image quality can decrease safety and security for the driver, the vehicle, or both. Various techniques for automatically cleaning the optical device (e.g., a lens of the optical device) have been proposed, such as water sprayers, mechanical wipers and air jet solutions, however, these techniques are not practical and tend to be costly to implement.

### SUMMARY

In an example, a method can include applying sequences that include at least one driver signal adapted to drive a transducer adaptively coupled to a top cover. The transducer can be excited based on the sequences to vibrate the top cover to remove a contaminant from a surface of the top cover. The applying of the sequences can include applying a first sequence to the transducer based on a first set of sequence parameters, applying a second sequence to the transducer based on a second set of sequence parameters, and applying a third sequence to the transducer based on a third set of sequence parameters.

In another example, a device can include driver circuitry that can be configured to generate transducer signals at an output, and a controller. The controller can include memory storing machine readable instructions for controlling the driver circuitry. The machine readable instructions can cause the driver circuitry to generate first driver signals having signal and timing characteristics based on a first set of sequence parameters, generate a second driver signal having signal and timing characteristics based on a second set of sequence parameters, and generate third driver signals having signal and timing characteristics based on a third set of sequence parameters. The first, second and third driver signals can correspond to the transducer signals and can be adapted to drive a transducer to vibrate a top cover to remove a contaminant from a surface of the top cover.

In an even further example, a method can include generating expulsion sequences based on a set of sequence parameters. Each expulsion sequence can include driver signals. The driver signals of each expulsion sequence can be separated in time over a given time interval based on a time parameter of the set of sequence parameters. The method can further include applying each of the expulsion sequences by adaptively driving a transducer to vibrate a top cover to remove a contaminant from a surface of the top cover. The application of each expulsion sequence to the transducer can vibrate the top cover to remove at least a portion of the contaminant from the top cover.

### BRIEF DESCRIPTION OF THE DRAWINGS

FIG. 1 illustrates an example of an ultrasonic lens cleaning (ULC) system.

FIG. 2 illustrates a schematic cross-sectional side view of an example of an optical protection apparatus.

FIG. 3 illustrates an example of a waveform diagram of a plurality of sequences that can be generated by an ULC system.

FIG. 4 illustrates another example of a waveform diagram of a plurality of sequences that can be generated by an ULC system.

FIG. 5 illustrates an example of a waveform diagram of a ULC system impedance magnitude and phase response over a broad frequency range.

FIG. 6 illustrates an example of a method for cleaning contaminants from an optical protection apparatus.

FIG. 7A-7B illustrates another example of a method for cleaning contaminants from an optical protection apparatus.

### DETAILED DESCRIPTION

This disclosure relates to systems and methods for ultrasonic cleaning of a top cover for a sensor device. Remote optical sensor devices, such as cameras, range detectors, etc. often include a top cover to protect an optical device from its surrounding environment. The top cover is configured to pass received light from surrounding areas optically to the optical device, such that the optical device can generate an image of a remote location. The top cover can become contaminated from the surrounding environment. Once contaminated, the resulting images generated by the optical device are degraded (e.g., of a lower quality). To remove the contaminants from (e.g., a surface of) the top cover, a transducer can be coupled to the top cover and excited (e.g., driven) to vibrate the top cover. The vibration causes the top cover to shake away the contaminants and leave a clean top cover. However, existing transducer driving techniques cannot effectively clean the lens element during heavy rain conditions (e.g., downpour conditions) or remove materials that have become stuck (e.g., difficult to remove), such as mud, to the top cover. In an example, the present disclosure describes systems and methods for driving a transducer that allow for continuous water expulsion and removal of materials from a top cover, as may be desirable in a variety of camera applications (e.g., automotive-driver assist, automotive-autonomous vehicle, security, etc.). In some examples, an ultrasonic lens cleaning (ULC) system can be configured to generate sequences for transducer driving that allows for removal of liquid materials, such as during heavy rain conditions, and difficult-to-remove materials from the top cover.

For the example of heavy rain conditions, the ULC system is configured to provide sustained cleaning of the top cover by applying a plurality of expulsion sequences characterizing a plurality of transducer driver signals. For example, the ULC system can be configured to set signaling parameters (e.g., an amplitude, a frequency or a frequency sweep range, and a duration) of the transducer driver signals, a number of times that the expulsion sequence is to be applied to the transducer, and an off time (e.g., time between respective transducer driver signals), such that the top cover can be effectively cleaned during such heavy rain conditions. Thus, the ULC system allows the top cover to remain free of water and the ULC system can provide clearer images of the remote location compared to existing optical devices.

In additional or alternative examples, the ULC system is configured to remove difficult contaminants materials from the top cover. For example, to remove the contaminants, such as dirt and sludge, that can be stuck to the top cover, the ULC system is configured to apply a set of sequences with transducer driver signals to remove the contaminants from the top cover. The set of sequences can include a dehydration sequence, a heating sequence and an expulsion sequence. To remove the contaminants that are stuck to the top cover, the ULC system can be configured to apply the set of sequences to the transducer and vibrate the top cover according to the driver signal generated for each sequence. For example, the ULC system can be configured to set the signaling parameters of the transducer driver signals for each sequence, a number of time that each sequence from the set of sequences is to be applied to the transducer, and the off time (e.g., time between respective transducer driver signals of the given sequence), such that difficult materials adhered (e.g., stuck) to the top cover can be removed. The ULC system also can be configured to apply sequences to the transducer in a manner that mitigates excessive heat buildup at the transducer. With reduced heating, failure of the transducer (e.g., transducer depolarization, glue failure, etc.) can be reduced, thereby extending an operating lifetime of the transducer.

The systems and devices described herein, such as the ULC system, can be integrated into an integrated circuit (IC) that can be mounted on a surface of a printed circuit board (PCB). In other examples, the systems described herein can be provided as plug-in elements that can be coupled to sockets (e.g., receiving terminals) of the PCB including elements to implement one or more functions, as described herein.

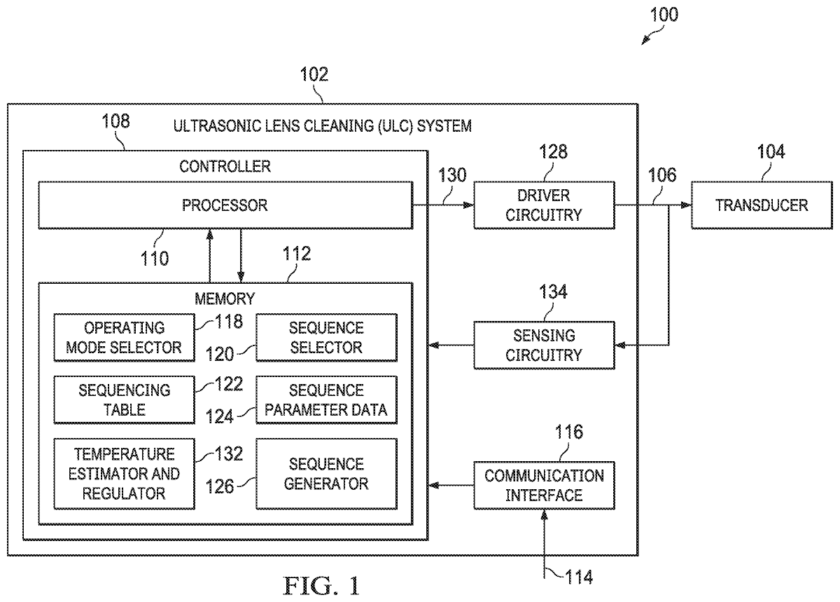

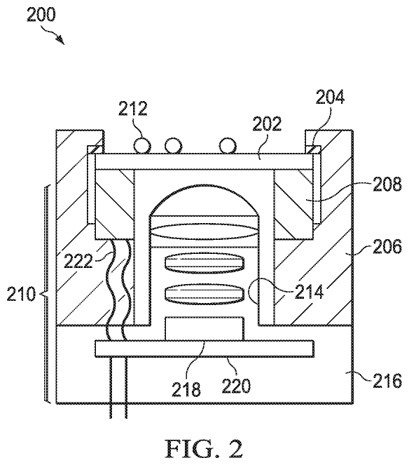

FIG. 1 illustrates an example of an ultrasonic lens cleaning (ULC) system 102. The ULC system 102 is configured to remove contaminants from an optical protection apparatus or other types of sensors. Optical devices, such as cameras, can include (e.g., be configured with) an optical protection apparatus to protect an optical device from contamination and damage. In some examples, the optical protection apparatus corresponds to an optical protection apparatus, as described in U.S. patent application Ser. No. 15/696,752 (“the '752 patent application”), entitled “Optical Device Housing,” which is hereby incorporated by reference in its entirety. In other examples, the optical protection apparatus is the apparatus 200 as illustrated in FIG. 2. The term contaminant and its derivatives, as used herein, can include any solid material or liquid material that can come into contact with the optical protection apparatus and at least partially obstruct, blur or cloud the optical device (e.g., video camera), such that degraded images are generated by the optical device (e.g., lower quality images). Thus, the term contaminant can encompass different types of solids and liquids that may come from a surrounding environment and contact an exposed surface of the optical protection apparatus. Example contaminants can include dirt, dust, water (e.g., water droplets, snow and ice), moisture, feces (e.g., bird poop), sap (e.g., tree sap), pigmented liquids (e.g., paint), etc.

By way of example, the ULC system 102 is configured to provide transducer driver signals to excite a transducer 104 (in the optical protection apparatus) that is operative coupled to a top cover (e.g., a lens cover in the optical protection apparatus). The top cover is configured to protect the optical device (e.g., a camera lens) from the environmental contaminants. For example, the ULC system 102 is configured to provide one or more transducer driver signals 106 (referred to herein as “transducer driver signal”) to excite the transducer 104 for vibrating the top cover. The transducer 104 thus may vibrate the top cover at very high frequencies, and act to break up the contaminants (e.g., surface tension, overcome adhesion due to electrostatic and/or Van der Waals forces), and otherwise shake the contaminants away from the top cover. However, extensive application of the ultrasonic vibration can be damaging to the transducer 104 itself or the optical protection apparatus, as extensive excitation of the transducer 104 may cause the transducer 104 to build heat up (e.g., increase in operating temperature).

In an example, the ULC system 102 is configured to mitigate heat buildup (e.g., heating) of the transducer 104 by selectively controlling signal and timing characteristics of the transducer driver signal 106, such that the transducer 104 can continue to operate within a safe temperature range or below a temperature reference, thereby extending an operating lifetime of the transducer 104. As described herein, the selective control of the signal and timing characteristics of the transducer driver signal 106 reduces transducer overheat conditions (e.g., excessive temperatures) and mitigates transducer failure modes and ultrasonic mechanical effects (e.g., physical effects on the apparatus) caused by vibration of the transducer 104, such as transducer adhesion failure with respect to the optical protection apparatus. As further described herein, the ULC system 102 can be configured to operate in a plurality of operating modes and during each operating mode apply respective sequences (e.g., transducer driver signal(s)) to the transducer 104 in a manner that mitigates excessive heat buildup in the transducer 104 while still vibrating the top cover to break up and remove unwanted contaminants from the top cover.

In some examples, the ULC system 102, is, or is incorporated into, or is coupled (e.g., connected) to an electronic system (not shown in FIG. 1), such as a computer, an electronics control box or display, controllers (e.g., wireless transmitters or receivers), or any type of electronic system configured to process information. In other examples, the ULC system 102 forms part of (e.g., is integrated into) the optical protection apparatus. In additional or alternative examples, the ULC system 102 includes the transducer 104.

As illustrated in FIG. 1, the ULC system 102 includes a controller 108. The controller 108 includes at least one processor 110 (e.g., a central processing unit (CPU)) and a memory 112. By way of example, the CPU can be a complex instruction set computer (CISC)-type CPU, reduced instruction set computer (RISC)-type CPU, microcontroller unit (MCU), or digital signal processor (DSP). The memory 112 can include random access memory (RAM)). In additional examples, the memory 112 includes other types of memories (e.g., on-processor cache, off-processor cache, RAM, flash memory, or disk storage).

The memory 112 can include coded instructions (e.g., computer and/or machine readable instructions) that can be representative of a lens cleaning application that can be executed by the processor 110 to implement at least some of the functions described herein. The application once executed by the processor 110 can be configured to operate the ULC system 102 in a given operating mode. In some examples, the lens cleaning application may be implemented on a circuitry controller as disclosed in U.S. patent application Ser. No. 15/492,286 (the '286 patent application), entitled “Methods and Apparatus Using Multistage Ultrasonic Lens Cleaning for Improved Water Removal,” which is hereby incorporated by reference in its entirety.

By way of example, upon initiation of the ULC system 102, the ULC system 102 is configured to enter a first operating mode. In the first operating mode, the ULC system 102 can be configured to function in a stand-by state (e.g., an idle state) during which the ULC system 102 can be configured to monitor for a mode signal 114. The mode signal 114 can identify (e.g., set) an operating mode of the ULC system 102. The mode signal 114 can be received at a communication interface 116 of the ULC system 102. The ULC system 102 may employ the communication interface 116 to communicate over a communication channel (e.g., a physical or a wireless channel) with an external system (not shown in FIG. 1), such as a user input device (e.g., a vehicle console). Thus, the external system can be configured to generate the mode signal 114 (e.g., in response to user input). By way of further example, the ULC system 102 is configured to operate in a second operating mode, such as in response to determining that a liquid material (e.g., water) is on (e.g., a surface of) the top cover. In some examples, the ULC system 102 is configured to switch operating modes, such as to the second operating mode based on the mode signal 114 (e.g., providing an indication that the ULC system 102 is to operate in the second operating mode corresponding to an indication that the liquid material is present on the top cover). In heavy rain conditions, the second operating mode may be employed by the ULC system 102 to remove the liquid materials, and thereby clean the top cover.

In additional or alternative examples, the ULC system 102 is configured to operate in a third operating mode, such as in response to determining that a solid material (e.g., dirt) is on the top cover. In some examples, the ULC system 102 is configured to switch operating modes, such as to the third operating mode based on the mode signal 114 (e.g., providing an indication that the ULC system 102 is to operate in the third operating mode corresponding to an indication that the solid material is present on the top cover). In examples, wherein difficult to remove solid materials are attached to the top cover (e.g., such as mud, feces, sap, paint, etc.), the third operating mode may be employed by the ULC system 102 to remove the solid material attached (e.g., stuck) to the top cover, and thereby clean the top cover.

In some examples, the ULC system 102 is configured to operate in a given operating mode, such as the second operating mode or the third operating mode, until the given operating mode is disabled, for example, based on the user input. In other examples, a mode duration parameter can be associated with the given operating mode and can specify an amount of time that the ULC system 102 is to function in the given operating mode. The mode duration parameter for the given operating mode may be predetermined and stored in the memory as part of parameter data (e.g., the sequencing parameter data 124), as described herein. The ULC system 102 can be configured to switch from the given operating mode to another operating mode, such as the first operating mode (e.g., based on the mode duration parameter or based on the user input). In other examples, the ULC system 102 is configured to switch mode of operations based on a number of sequences of a given sequence that have been applied to the transducer 104, as described herein.

In some examples, the communication interface 116 is configured to provide the mode signal 114 to the controller 108. The memory 112 can include an operating mode selector 118. The operating mode selector 118 can be programmed to configure the ULC system 102 to operate in the given operating mode based on mode selection data corresponding to the mode signal 114. Thus, the mode selection data can set (e.g., identify) the operating mode for the ULC system 102. The memory 112 can further include a sequence selector 120. The sequence selector 120 can be programmed to evaluate a sequencing table 122 to identify one or more sequences for generating the transducer driver signal 106. For example, in response to the operating mode selector 118 determining that the ULC system 102 is to function in the given operating mode (e.g., the second operating mode or the third operating mode) based on the mode selection data, the sequence selector 120 can be programmed to identify the one or more sequences.

The sequencing table 122 can characterize a plurality of sequences that can be applied to the transducer 104, such as during the second operating mode or the third operating mode. For example, the one or more sequences include a temperature sequence, a dehydration sequence, a heating sequence, and an expulsion sequence. The temperature sequence can be applied to the transducer 104 to determine (e.g., estimate) a temperature of the transducer, as described herein. The dehydration sequence can be applied to the transducer 104 to vibrate the top cover, such that the contaminant becomes dehydrated. The heating sequence can be applied to the transducer 104 to vibrate the top cover to heat the contaminant on the top cover. The expulsion sequence can be applied to the transducer 104 to vibrate the top cover to expel the contaminant from the top cover. In some examples, a different logical paradigm (e.g., structure, model, etc.) is used than the sequencing table 122. Each sequence can be implemented according to values of sequence parameters.

For example, the sequence parameters for each sequence are stored in the memory 104 as sequence parameter data 124. Thus, in some examples, the sequencing table 122 includes the sequence parameter data 124. To implement each sequence with respect to the transducer 104, the ULC system 102 can be configured to control the signal and timing characteristics of the transducer driver signal 106 based on the sequence parameters for each sequence. The signal characteristics, for example, can include an amplitude and a frequency for the transducer driver signal 106. The timing characteristics can include an active time of the transducer driver signal 106 (e.g., an amount of time that the transducer driver signal 106 is active (e.g., high)), and an amount of time between respective active transducer driver signals 106 for an associated sequence. For example, to apply the temperature sequence to the transducer 104, the ULC system 102 is configured to supply the transducer 104 with the transducer driver signal 106 having signal and timing characteristics as defined by the sequence parameter data 124 associated with the temperature sequence stored in the sequencing table 122.

As a further example, the sequence parameters (e.g., stored as the sequence parameter data 124) for a given sequence can include one of an amplitude parameter, a frequency parameter, a signal duration parameter, a signal delay parameter, or any combination thereof. The amplitude parameter can set the amplitude of the transducer driver signal 106. The frequency parameter can set the frequency of the transducer driver signal 106. In some examples, the frequency parameter is a frequency sweep parameter and can set a frequency range (e.g., a sweep of frequencies) of the transducer driver signal 106. The signal duration parameter can set the active time that the transducer driver signal 106 is applied. Thus, the signal duration parameter can define a vibration time interval for the transducer 104 during which the transducer 104 is excited, thereby vibrating the top cover. The signal delay parameter can set the amount of time between respective transducer driver signals 106 for the given sequence.

The ULC system 102 is configured to apply the given sequence to the transducer 104 by supplying the transducer 104 with the transducer driver signal 106 having timing and signal characteristics as defined by the sequence parameters for the given sequence. In some examples, a plurality of transducer driver signals 106 associated with the given sequence have similar signal and timing characteristics. In other examples, the plurality of transducer driver signals 106 have different signal and timing characteristics for the given sequence. Each of the transducer driver signals 106 can be separated in time based on the signal delay parameter for the given sequence, such that the ULC system 102 can control the amount of time between application of the transducer driver signals 106 to the transducer 104 during the given sequence application.

In some examples, the ULC system 102 is configured to apply sequences to the transducer 104 according to a sequencing order that can be specified by data in the sequencing table 122. Each sequence can be associated with one or more sequencing orders. The sequence selector 120 can be programmed to evaluate the sequencing table 122 to identify a given sequencing order from the one or more sequencing orders based on the given operating mode. For example, in response the operating mode selector 118 providing an indication that the given operating mode (e.g., the second operating mode or the third operating mode) has been selected, the sequence selector 120 can be programmed to identify the given sequencing order based on the identified operating mode. Thus, the sequence selector 120 can be programmed to identify the given sequencing order based on the mode selection data corresponding to the mode signal 114.

The sequence selector 120 can be programmed to identify each sequence associated with the given sequencing order and respective sequence parameters for each identified sequence, such that appropriate transducer driver signals 104 can be generated for each identified sequence in the given sequencing order. Each of the one or more sequencing orders can include or be associated with sequencing cleaning logic (e.g., instructions) for applying each identified sequence to the transducer 104, such that the transducer 104 can be excited and vibrate the top cover to remove the contaminants. The sequencing cleaning logic can characterize an amount of time between respective sequences, a number of times that each sequence associated with the given sequencing order is to be applied to the transducer 104, one or more count threshold values indicative of a time delay, one or more temperature threshold values, and/or one or more safe temperature operating ranges. In some examples, the sequencing cleaning logic is stored as part of the sequencing table 122.

As an example, the one or more sequencing orders can include a first sequencing order that includes the expulsion sequence and, in some examples, the temperature sequence. In other examples, the temperature sequence is part of another sequencing order (e.g., which can include only the temperature sequence). The sequence selector 120 can be programmed to select the first sequencing order and the associated sequencing cleaning logic to apply each sequence. For example, the sequencing cleaning logic is programmed to apply each sequence in the first sequencing order in response to the operating mode selector 118 providing an indication that the second operating mode has been selected for the ULC system 102.

In another example, the one or more sequencing orders include a second sequencing order that includes the dehydration sequence, the heating sequence and the expulsion sequence. In yet other examples, the second sequencing order includes a temperature sequence. The sequence selector 120 can be programmed to select the second sequencing order and the associated sequencing cleaning logic to apply each sequence to the transducer 104. For example, the sequencing cleaning logic is programmed to apply each sequence in the second sequencing order in response to the operating mode selector 118 providing an indication that the third operating mode has been selected for the ULC system 102. In some examples, at least some of the temperature sequences are omitted from the first sequencing order, the second sequencing order or both.

In further examples, the sequence selector 120 is programmed to provide the sequence parameters corresponding to the sequencing parameter data 124 for each sequence associated with the given sequencing order and related sequencing cleaning logic to a sequence generator 126. The sequence generator 126 can be executed by the processor 110. The sequence generator 126 can be programmed to control driver circuitry 128 for generating the transducer driver signal 106 based on the sequence parameters for each sequence associated with the given sequencing order. Thus, the sequence generator 126 can be programmed to control the driver circuitry 128 to apply each sequence during the given operating mode by generating the transducer driver signal 106 having signal and timing characteristics as defined by the sequence parameters for the respective sequence.

In some examples, the driver circuitry 128 includes pulse-width modulation (PWM) circuitry. The PWM circuitry can include a PWM switching controller, a PWM PreDriver circuit, and an output stage. In an example, the PWM circuitry corresponds to a PWM circuitry as described in U.S. patent application Ser. No. 15/903,569 (“the '569 patent application”), entitled “Transducer-Induced Heating and Cleaning,” which is hereby incorporated by reference in its entirety. In other examples, the PWM PreDriver circuit is omitted from the PWM circuitry. The output stage can include a plurality of switches that can be coupled to a bus voltage (not shown). The transducer driver signal 106 can be generated by the output stage based on the bus voltage according to the sequence parameters for the given sequence. The output stage can be configured to drive the transducer 104 with the transducer driver signal 106, thereby vibrating the top cover. In an example, the output stage is a class D driver. In other examples, the driver circuitry 128 is representative of a direct digital synthesis (DDS) circuit.

As a further example, the processor 110 is configured to output a driver control signal 130 based on the sequence parameters for the given sequence. For example, the sequence generator 126 is be programmed with instructions that, when executed by the processor 110, cause the driver circuitry 128 to generate the transducer driver signal 106 based on the driver control signal 130. In some examples, the driver control signal 130 characterizes the amplitude, the frequency (e.g., a sweeping frequency), and the signal width (e.g., the amount time that the transducer driver signal 106 is active). The driver circuitry 128 can be configured to supply the transducer 104 with the transducer driver signal 106 having signal and timing characteristics as defined by the sequence parameters for the given sequence based on the driver control signal 130. The sequence generator 126 can be programmed to control the amount of time between the outputting (e.g., generation) of the driver control signal 130 by the processor 110 based on the sequence parameters (e.g., such as the signal delay parameter) to control the amount of time between respective transducer driver signals 106 for the given sequence. In other examples, the sequence generator 126 is programmed to control the amount of time between respective sequences or a number of times that each sequence is to be applied to the transducer 104. In some examples, the controller 108 is configured to provide each driver control signal 130 as an analog signal.

In further examples, the memory 112 includes a temperature estimator and regulator 132. In some examples, the temperature estimator and regulator 132 is implemented in a similar manner as a temperature estimator and regulator, as described in the '569 patent application. The temperature estimator and regulator 132 can be configured to estimate the temperature of the transducer 104 and regulate the application of each sequence associated with the given sequencing order to the transducer 104 based on the estimated temperature. For example, the temperature estimator and regulator 132 can be programmed to determine if the transducer 104 is operating outside a given temperature operating range (e.g., a safe operating range, such as about − (minus) 40° Celsius (C) to about 60° C.) or at or above a given temperature threshold (e.g., 60° C.), as defined by the sequencing cleaning logic associated with the given sequencing order. The temperature estimator and regulator 132 can be programmed to instruct the sequence generator 126 to delay a subsequent application of the given sequence (or a different sequence) (e.g., for a given period of time, such as at least one (1) second) until the transducer 104 has been given time to cool off based on the determination.

The temperature of the transducer 104 can be estimated (e.g., determined) prior to or after each non-temperature sequence applied to the transducer 104, such as the dehydration sequence, the heating sequence, and the expulsion sequence. In other examples, the temperature of the transducer 104 is estimated after a given number of non-temperature sequences have been applied to the transducer 104. As mentioned, if the temperature estimator and regulator 132 determines the transducer temperature is outside the given temperature operating range or is equal to or greater than the given temperature threshold, the sequence generator 126 can be programmed to delay application of a subsequent sequence to the transducer 104 (e.g., a predetermined duration or until the transducer has sufficiently cooled off). For example, the temperature estimator and regulator 132 estimates and evaluates the transducer temperature (e.g., continuously in a loop) until it determines that the transducer temperature is within the given temperature operating range or is below the given temperature threshold for the transducer 104. The subsequent sequence may be the same or similar to prior sequence that has been applied to the transducer 104 or a different sequence that is to be applied to the transducer 104.

By way of example, the temperature of the transducer 104 is estimated by applying the temperature sequence to the transducer 104 and evaluating an impedance response (e.g., an electrical impedance response) of the transducer 104 based on the applied temperature sequence. The temperature estimator and regulator 102 can be configured to employ the impedance response of the transducer 104 to provide an estimate temperature (e.g., an operating temperature) for the transducer 104. In some examples, the ULC system 102 is configured to evaluate the impedance response to estimate the transducer temperature in a same or similar manner as described in the '569 patent application. The impedance response of the transducer 104 can vary according to the temperature of transducer 104. The relationship between the estimated temperature of transducer 104 and the impedance response of the transducer 104 is substantially linear outside the resonant frequency regions of the transducer 104. Because the temperature of the transducer 104 is linear outside the resonant frequency regions of the transducer 104, the impedance of the transducer 104 can be measured by applying a temperature sequence with transducer driver signals 104 having an operating frequency outside a given resonance frequency region of the transducer 104. In other examples, a different temperature estimation technique is used by the ULC system 102 to determine the operating temperature of the transducer 104.

For example, a temperature variable T of the transducer 104 can be expressed as a function of an impedance variable impedance (Z) of the transducer 104 according to:

T=−0.29*Z+392.6 (1),

wherein the constant “−0.29” is a slope of the linear equation, and the constant “392.6” is a y-intercept of the linear equation). The slope and y-constants of equation (1) can be determined from the physical characteristics of the transducer 104 (e.g., type of transducer).

The variable temperature T as a function of the impedance variable Z for the transducer 104 can also be expressed as a parabolic equation:

T=A*Z²+B*Z+C (2),

where A, B and C are constants. When A=0, Equation (2) is reduced to the linear form (such as the form of Equation (1)). Accordingly, the operating frequency can be selected from within a frequency region (e.g., outside of a resonance frequency region) within which the relationship between the estimated temperature and the measured impedance can be determinable as a quadratic function (e.g., according to the Equation (2)).

Impedance data over a range of temperatures for a selected operating frequency or frequency operating range can be measured at discrete temperatures and stored as a lookup table in the memory 112 (e.g., which reduces processing requirements for calculating the equation otherwise calculated to determine an instant operating temperature). In some examples, (e.g., one or two dimensional) linear interpolation can be used to more precisely determine the operating temperature (e.g., depending on a particular application of the described techniques). Thus, the lookup table can specify at least one temperature and at least one impedance of the transducer 104 for each frequency region of the transducer 104 over which the at least one temperature has a linear relationship with the at least one impedance.

In some examples, the ULC system 102 is configured to apply the temperature sequence to the transducer 104 and employ sensing circuitry 134 to measure the impedance of transducer 104 (e.g., by measuring the voltage with respect to the transducer 104). For example, the transducer 104 can be excited to vibrate at the operating frequency outside a given resonance frequency region in which the impedance of the transducer 104 is linear. The sensing circuitry 134 can be configured to monitor a response of the transducer 104 based on the transducer driver signal 106. The sensing circuitry 134 is configured to generate signaling (e.g., current or voltage signals) based on the monitored response. In some examples, the signals generated by the sensing circuitry 134 are analog signals and the ULC system 102 employs an analog-to-digital converter (ADC) (not shown in FIG. 1) for sampling and converting the analog signals to corresponding digital signals.

The processor 110 can be configured to receive the digital signals. For example, the temperature estimator and regulator 132 is configured to cause the processor 110 to process the digitals signals to estimate the temperature of the transducer 104 corresponding to the measured impedance of the transducer 104. The temperature can be estimated for the transducer 104 according to the linear relationship between the impedance of the transducer 104 and the operating temperature of the transducer 104, which is stored in the memory 112. For example, the measured impedance can be converted to the estimated temperature by circuits or the temperature estimator and regulator 132 operating according to the function of Equation (1), and/or the measured impedance can be converted to the estimated temperature in response to indexing the lookup table with values for creating the output of Equation (1). The lookup table can include addressable values that can be referenced using the independent variable (e.g., the measured impedance) as the index, and that are output as results for providing or determining the value of the dependent variable. For example, the addressable values can be determined (e.g., pre-calculated before or after deployment of the ULC system 102) according to Equation (1).

In some examples, the temperature estimator and regulator 132 is configured to indicate that the temperature of the transducer 104 is outside the given temperature operating range or at or above the given temperature threshold. The sequence generator 126 can be programmed to delay a subsequent application of the given sequence (or a different sequence) (e.g., for a given period of time, such as at least one (1) second or until the transducer 104 has been given time to cool off) based on the temperature of the transducer 104. For example, the sequence generator 126 can be programmed to initiate a timer (not shown in FIG. 1) in response to the estimated temperature being outside the given temperature operating range or at or above the given temperature threshold for the transducer 104. The timer can be implemented in hardware, software or as a combination of both. The timer can be initiated by the sequence generator 126 for an interval of time corresponding to a time delay period (e.g., at least one (1) second).

The sequence generator 126 can be configured to compare (e.g., periodically, continuously) a time count value of the timer to a count threshold value. The sequence generator 126 can be programmed to communicate with the temperature estimator and regulator 132 to estimate (e.g., determine) the temperature of the transducer 104 in response to determining that the time count value is equal to the count threshold value. The temperature estimator and regulator 132 can be programmed to notify the sequence generator 126 that the estimated temperature is within the given temperature operating range at or above the given temperature threshold for the transducer 104.

Accordingly, the ULC system 102 can be configured to operate in a plurality of different modes, and during each mode apply a plurality of sequences, such that contaminants (e.g., liquid or solid materials) can be removed from the top cover in a manner that minimizes or reduces transducer overheating, and thus overheating of the optical protection apparatus.

For example, if the top cover has liquid material (e.g., on the surface of the top cover), the ULC system 102 is supplied with the mode signal 114 to switch the ULC system to the second (e.g., liquid removal) operating mode. The operating mode selector 118 can be programmed to notify the sequence selector 120 that the ULC system 102 is to operate in the second operating mode by supplying the sequence selector 120 with mode operation information for the second operating mode. The sequence selector 120 can be programmed to evaluate the sequencing table 122 to identify the first sequencing order characterizing an order of application of sequences to the transducer 104 for removal of the liquid material based on the mode operation information.

As an example, the first sequencing order includes the temperature sequence and the expulsion sequence. The sequencing cleaning logic for the first sequencing order can include a sequence counter parameter specifying a number of times that each sequence of the first sequencing order is to be applied to the transducer 104, and a temperature parameter specifying one of the given temperature operating range or the given temperature threshold indicative of a safe operating temperature for the transducer 104. With respect to the first sequencing order, the ULC system 102 can be configured to apply the temperature sequence by vibrating the transducer 104 with the transducer driver signal 106 having signal and timing characteristics as defined by the sequence parameters associated with the temperature sequence. The temperature estimator and regulator 132 can estimate the temperature of the transducer 104 based on the transducer driver signal 106 of the temperature sequence. If the estimated temperature is less than the given temperature threshold or within the given temperature operating range, as defined by the sequencing cleaning logic for the first sequencing order, the ULC system 102 can be configured to apply the expulsion sequence to transducer 104 to expel the liquid material from the top cover. The transducer 104 can be excited with the transducer driver signal 106 having signal and timing characteristics as defined by the sequence parameters associated with the expulsion sequence.

In some examples, the ULC system 102 is configured to determine if the expulsion sequence is to be re-applied to clean the top cover. For example, the sequence generator 126 is configured to compare the number of times that a non-temperature sequence, such as the expulsion sequence, has been applied to the transducer 104 to the sequence counter parameter characterized by the sequencing cleaning logic. If the number of times that the expulsion sequence has been applied to the transducer 104 is less than the sequence count parameter, the ULC system 102 can be configured to re-apply the expulsion sequence. If the number of times that the expulsion sequence has been applied to the transducer 104 is equal to the sequence counter parameter, the sequence generator 126 can be programmed to cause the ULC system 102 to switch mode of operations from the second mode of operation to another operating mode, such as the first operating mode, and idle (e.g., wait for another mode signal 114). The ULC system 102 can be configured to switch to the other operating mode in response based on the other mode signal 114. In some examples, if the number of times that the expulsion sequence has been applied to the transducer 104 is less than the sequence counter parameter, the sequence generator 126 is programmed to communicate with the temperature estimator and regulator 132 to re-estimate the temperature of the transducer 104 before a subsequent expulsion sequence application. The ULC system 102 can be configured to delay subsequent expulsion sequence application for a period of time to allow the transducer 104 to cool down.

Accordingly, in the second operating mode, the ULC system 102 is configured to remove the liquid material by vibrating the top cover by applying expulsion sequences to the transducer 104. Following each expulsion sequence application, the ULC system 102 can be configured to estimate the temperature of the transducer 104, and delay a subsequent expulsion sequence application in response to determining that the transducer 104 is overheating or apply the subsequent expulsion sequence to continue with the removal of the liquid material from the top cover according to the second sequencing order.

In additional or alternative examples, if the top cover has contaminants (e.g., on the surface of the top cover), such as the solid material, the ULC system 102 is supplied with the mode signal 114 that provides an indication that the ULC system 102 is to switch operating modes, such as from the first operating mode to the third operating mode. The operating mode selector 118 can be programmed to notify the sequence selector 120 that the ULC system 102 is to operate in the third operating mode by supplying the sequence selector 120 with mode operation information for the third operating mode. The sequence selector 120 can be programmed to evaluate the sequencing table 122 to identify the second sequencing order characterizing an order of sequences to apply to the transducer 104 for removal of the solid material based on the mode operation information.

The sequences for removal of the solid material can include the dehydration sequence, the heating sequence, the expulsion sequence, and the temperature measurement sequence. The second sequencing order can be associated with or include associated sequencing cleaning logic. The sequencing cleaning logic for the second sequencing order can include the sequence counter parameter and the temperature parameter, as described herein. Under the second sequencing order, in some examples, following each given non-temperature sequence, the ULC system 102 is configured to determine if the given non-temperature sequence is to be re-applied to the top cover. For example, the sequence generator 126 is configured to compare the number of times that the given non-temperature sequence, such as the expulsion sequence, has been applied to the transducer 104 to the sequence counter parameter. If the number of times that the given non-temperature sequence has been applied to the transducer 104 is less than the sequence count parameter, the ULC system 102 can be configured to re-apply the given non-temperature sequence. If the number of times that the given non-temperature sequence has been applied to the transducer 104 is equal to the sequence counter parameter, the sequence generator 126 can be programmed to cause the ULC system 120 to switch mode of operations from the third mode of operation to another operating mode, such as the first operating mode, and idle. In some examples, the ULC system 102 is configured to receive another mode signal 114 that provides an indication that the ULC system 102 is to switch to the other operating mode. The ULC system 102 can be configured to switch to the other operating mode based on the other mode signal 114.

In some examples, if the number of times that the given non-temperature sequence has been applied to the transducer 104 is less than the sequence counter parameter, the sequence generator 126 is programmed to communicate with the temperature estimator and regulator 132 to re-estimate the temperature of the transducer 104 before applying a subsequent given non-temperature sequence (or a different non-temperature sequence). The ULC system 102 can be configured to delay the given non-temperature sequence for a period of time until the transducer 104 has cooled down.

Accordingly, in the third operating mode, the ULC system 102 can be configured to remove solid materials by vibrating the top cover by applying the dehydration sequence, the heating sequence, and the expulsion sequence to the transducer 104. Following each given non-temperature sequence application, during the third operating mode, the ULC system 102 can be configured to estimate the temperature of the transducer 104 and delay a subsequent non-temperature sequence application in response to determining that the transducer 104 is overheating (e.g., for a period of time until the transducer 104 has cooled off) or apply the subsequent non-temperature sequence to continue with the removal of the solid material from the top cover according to the third sequencing order.

FIG. 2 is a schematic cross-sectional side view of an example of an optical protection apparatus 200. The optical protection apparatus 200 includes a top cover 202, a seal 204, a housing 206, a transducer 208, and a camera 210. The transducer 208 can be configured to operate at a selected frequency (e.g., at a factory-selected frequency or an operator-selected frequency that is within a given resonance frequency region of the transducer 208), such that a contaminant 212 (e.g., moisture, dirt, and other foreign materials) on an (e.g., upper) surface of the top cover 202 is dispersed. In some examples, the transducer 208 is the transducer 104, as illustrated in FIG. 1. Thus, the transducer 208 can be configured to vibrate at a given frequency within one or more associated resonance frequency regions of the transducer 208.

By way of example, the top cover 202 can be a transparent element, such that light can pass there through, and can be elastically captivated in a distal (e.g., upper) portion of the housing 206. In some instances, the top cover 202 can be a focusing lens (e.g., for refractively focusing light). The top cover 202 can be arranged to receive light from surrounding areas and optically provide the received light to a camera lens 214 of the camera 210. As illustrated in FIG. 2, the top cover 202 is arranged to protect the camera lens 214 from the contaminant 212. The top cover 202 can be elastically captivated to the housing 206 by a seal the (e.g., a rubber seal) to prevent the contaminant 212 from contaminating the camera lens 214.

The camera lens 214 can direct the received light toward a camera base 216. The camera base 216 includes a photodetector 218 and circuitry 220. The photodetector 220 can be configured to receive the light. Although the camera 210 in the example of FIG. 2 is illustrated as including a single photodetector 218, in other examples, the camera 210 can include a plurality of photodetectors 218 that can be configured to cooperate for generating electronic images (e.g., video streams) in response to the focused light coupled through the top cover 202 and the camera lens 214. In some examples, the circuitry 220 includes a printed circuit board, and, in some examples, one or more circuits for implementing the ULC system 102, as illustrated in FIG. 1. In others examples, the controller circuitry 220 can be coupled to external power, control, and information systems (e.g., in-car entertainment systems, vehicle dashboard, center console system, etc.) using wiring and/or optical conduits (e.g., electrical cables, fiber cables, etc.). In some examples, the transducer 208 is mechanically coupled to the top cover 202. The transducer 208 can be affixed to the top cover 202 by an intervening adhesive layer (e.g., a high-temperature resistant epoxy). In operation, the transducer 208 can be supplied via driver wiring 222 one or more transducer driver signals (e.g., the one or more transducer driver signals 106, as illustrated in FIG. 1). The transducer 208 can be configured to vibrate (e.g., at a resonance frequency) the top cover 202 based on the one or more transducer driver signals according to a given sequencing order (e.g., the first sequencing order, the second sequencing order, etc.) to remove the contaminant 212 from the surface of the top cover 202.

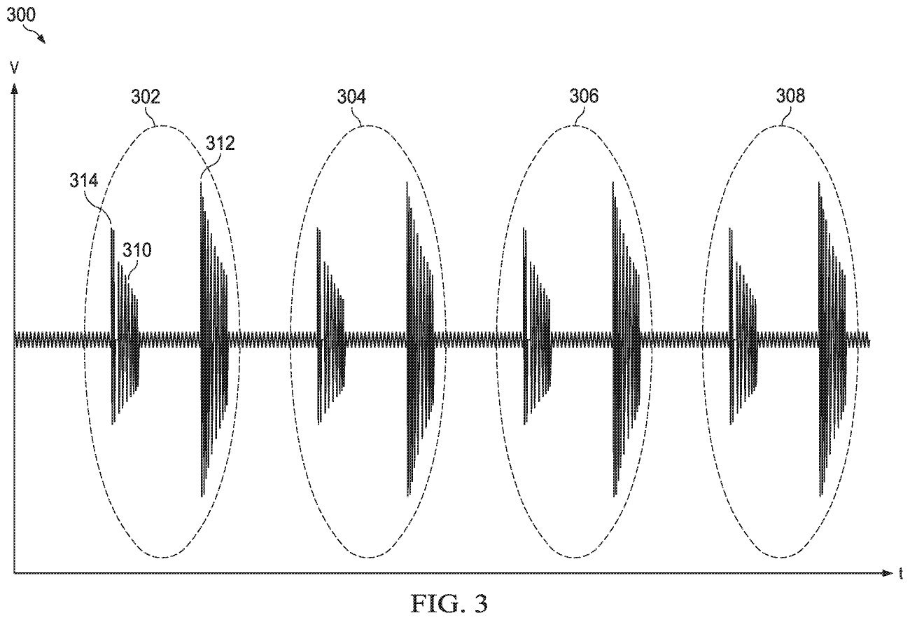

FIG. 3 illustrates an example of a waveform diagram 300 of a plurality of expulsion sequences 302 to 308 that can be generated by an ultrasonic lens cleaning (ULC) system. The ULC system can correspond to the ULC system 102 and the drive signals shown in the sequences 302 to 308 correspond to the drive signal 106, as illustrated in FIG. 1. As illustrated in the example of FIG. 3, a y-axis of the waveform diagram 300 represents an amplitude axis in volts (V) and an x-axis of the waveform diagram 300 represents a time axis in time (t). Each sequence 302 to 308 may include a first transducer driver signal 310 and a second transducer driver signal 312. In some examples, each sequence 302 to 308 includes a third transducer driver signal 314 that can be applied to a transducer (e.g., the transducer 104, as illustrated in FIG. 1) for determining the temperature of the transducer, as described herein (e.g., with respect FIG. 1). The transducer driver signals 310, 312, 314 can be generated for a given sequence 302 to 308 based on respective sequence parameters (e.g., the sequence parameter data 124, as illustrated in FIG. 1) associated with the given sequence 302 to 308. The ULC system can be configured to provide the first and second transducer driver signals 310, 312 with signal and timing characteristics, as defined by respective sequence parameters. In other examples, the first and second transducer driver signals 310, 312 for each sequence 302 to 308 can have different signal and timing characteristics. In some examples, the first and second transducer driver signals 310, 312 have a signal duration of about 100 milliseconds (ms). In other examples, the first and second transducer driver signals 310, 312 have a different signal duration. In even further examples, the third transducer driver signal 314 has a signal duration of about 3 ms. In other examples, the third transducer driver 314 signal has a different signal duration. As such, in some examples, the temperature measurement can be about 4 ms in time, wherein the third transducer driver signal 314 has a 3 ms signal duration and about 1 ms in delay time.

In further examples, the ULC system 102 is configured to generate the first and second transducer driver signals 310, 312 for a given sequence 302 to 308, such that the first and second transducer driver signals 310, 312 are separated in time from one another, as illustrated in FIG. 3. The amount of time between the generation of the first and second transducer driver signals 310, 312 can be based on the sequence parameters associated with the given sequence 302 to 308. In an example, the amount of time between the generation of the first and second transducer driver signals 310, 312 is about 250 milliseconds (ms). Thus, the ULC system 102 can be configured to control the amount of time between respective transducer driver signals 310, 312 for the given sequence 302 to 308 based on sequence parameters for the given sequence 302 to 308. In an example, a temperature sequence such as described with respect to FIG. 1 is applied before or after each of the first and second transducer driver signals 310, 312. In additional or further examples, the amount of time between the generation of the third transducer driver signal 314 and a subsequent transducer driver signal (e.g., the first transducer driver signal 310) is about 250 ms.

In some examples, the first transducer driver signal 310 has a frequency in a frequency range of about 120 kHz to about 140 kHz and the second transducer driver 312 has a frequency in a frequency range of about 150 kHz to about 170 kHz. By way of further example, the third transducer driver signal 314 has a frequency in a range of about 260 kHz to about 290 kHz. In additional or alternative examples, the first transducer driver signal 310 has a first sweep frequency range, and the second transducer driver signal 312 has a second sweep frequency range. The first sweep frequency range may include frequencies in a given resonance frequency region of a plurality of resonance frequency regions of the transducer. The second sweep frequency range may include frequencies in a same or another resonance frequency region of the plurality of resonance frequency regions of the transducer. In some examples, the given resonance frequency region is a higher frequency region of the transducer than the other resonance frequency region.

As shown in the example of FIG. 3, the first transducer driver signal 310 can have a first amplitude (e.g., a decreasing amplitude over its on-time over the time axis), and the second transducer driver signal can have a second amplitude (e.g., an increasing amplitude over its on-time over the time axis) that is greater than the first amplitude. In other examples, the first amplitude is less than the second amplitude. In some examples, the first transducer driver signal 310 has a different signal width (e.g., an activation time period) than the second transducer driver signal 312. In other examples, the first and second transducer driver signals 310, 312 have the same or similar signal widths. In additional or alternative examples, the first amplitude of the first transducer driver signal 310 is a peak-to-peak voltage (V_{PP}) in a range of about 120 V_{PP} to about 200 V_{PP}, and the second amplitude of the second transducer driver signal 312 is in a range of about 250 V_{PP} to about 350 V_{PP}. In further examples, an amplitude of the third transducer driver signal 314 is in a range of about 140 V_{PP} to about 160 V_{PP}.

Accordingly, the ULC system can be configured to apply at least a subset of sequences 302 to 308 to the transducer to excite the transducer and vibrate the top cover in a continuous manner. In this way, liquid materials (e.g., water) on the surface of the top cover can be removed quickly (e.g., during heavy rain conditions) without excessive heating of the transducer. Additionally, an operating life of the transducer may be extended along with the life of the optical protection apparatus in which the transducer is disposed.

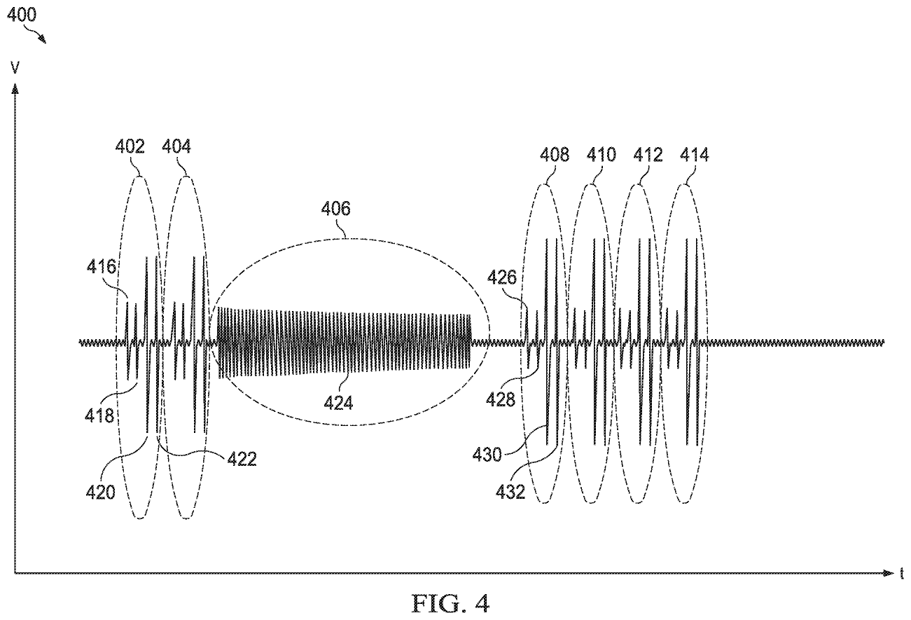

FIG. 4 illustrates an example of another waveform diagram 400 of a plurality of sequences that can be generated by an ultrasonic lens cleaning (ULC) system. The ULC system can correspond to the ULC system 102 and drive signals in the sequences 402 to 414 can correspond to the drive signal 106, as illustrated in FIG. 1. The set of sequences in FIG. 4 may be applied to remove contaminants, such as a solid material (e.g., dirt), from a top cover of an optical protection apparatus. As illustrated in the example of FIG. 4, a y-axis of the waveform diagram 400 represents an amplitude axis in volts (V) and an x-axis of the waveform diagram 400 represents a time axis in time (t).

The plurality of sequences 402 to 414 can include a plurality of dehydration sequences 402 to 404, a heating sequence 406, and a plurality of expulsion sequences 408 to 414. Each of the plurality of sequences 402 to 414 can be applied to the transducer to vibrate the top cover to remove the solid material on the top cover. Although FIG. 4 illustrates a plurality of dehydration sequences 402 to 404 and expulsion sequences 408 to 414. In other examples, a different number of dehydration and/or expulsion sequences may be used. In some examples, before or after the application of each of the sequences 402 to 414, the ULC system is configured to measure a temperature of the transducer, as disclosed herein. As such, in some examples, a temperature sequence is applied that has similar signal and timing characteristics, as described herein (e.g., such as with respect to FIG. 3). For example, the ULC system can be configured to apply a respective sequence 402 to 414 in response to determining that the temperature of the transducer is within a given temperature operating range or below a given temperature threshold.

By way of example, the ULC system is configured to apply the dehydration sequence 402 to the transducer, such that the solid material on the surface of the top cover is at least partially dehydrated. After at least partially dehydrating the solid material, the ULC system can be configured to apply the dehydration sequence 404 to further dehydrate the solid material. Correspondingly, the ULC system can be configured to apply the heating sequence 406 to the transducer to excite the top cover to at least partially dry the dehydrated solid material on the top cover. The application of the heating sequence 406 to the transducer causes heating of the dehydrated solid material. The ULC system can be configured to apply each of the expulsion sequences 408 to 414 in a sequential order to the transducer to vibrate the top cover to expel the dried and dehydrated solid material on the top cover, thereby cleaning the top cover of solid materials.

By way of example, each dehydration sequence 402 to 404 includes a plurality of dehydration driver signals 416 to 422 having similar or different signal and timing characteristics that can be applied to the transducer. Each of the dehydration driver signals 416 to 422 can be generated by the ULC system 202 for a given dehydration sequence 402 to 404 based on respective sequence parameters associated with the given dehydration sequence 402 to 404. The ULC system can be configured to generate each of the dehydration driver signals 416 to 422 for the given dehydration sequence 402 to 404, such that the plurality of dehydration driver signals 416 to 422 are separated in time (e.g., delayed) from one another. The amount of time between respective dehydration driver signals 416 to 422 for the given dehydration sequence 402 to 404 can be based on the sequences parameters associated with the given sequence 402 to 404.

In additional or alternative examples, a subset of the dehydration driver signals 416 to 422 have a first sweep frequency range and another subset of the dehydration driver signals 416 to 422 have a second sweep frequency range. The first sweep frequency range may include frequencies in a given resonance frequency region of a plurality of resonance frequency regions of the transducer. The second sweep frequency range may include frequencies in a same or another resonance frequency region of the plurality of resonance frequency region of the transducer. In some examples, the given resonance frequency region is a higher frequency region of the transducer than the other resonance frequency region. In some examples, at least some of the subset of the dehydration driver signals 416 to 422 have signal and timing characteristics, as described herein, such as similar to the first expulsion driver signal 310, as illustrated in FIG. 3. In additional or other examples, at least some of the other subset of the dehydration driver signals 416 to 422 have signal and timing characteristics, as described herein, such as similar to the second expulsion driver signal 312, as illustrated in FIG. 3.

In some examples, each of the dehydration driver signals 416 to 422 has a first amplitude (e.g., a decreasing amplitude over its on-time over the time axis) or a second amplitude (e.g., an increasing amplitude over its on-time over the time axis). The first amplitude can be greater than the second amplitude. In other examples, the second amplitude is greater than the first amplitude. In some examples, the dehydration driver signals 416 to 422 have different signal widths (e.g., an activation time period). In other examples, the dehydration driver signals 416 to 422 have the same or similar signal widths. In even further examples, a subset of the dehydration driver signals 416 to 422 have a given signal width and another subset of the dehydration driver signals 416 to 422 have another signal width.

In some examples, the heating sequence 406 includes a heating driver signal 424 having signal and timing characteristics as defined by the sequence parameters associated with the heating sequence 406 that can be applied to the transducer to heat the solid materials on the top cover. The heating driver signal 424 can have a given sweep frequency range that is within a given resonance frequency region of the transducer and an associated amplitude. In an example, the heating driver signal 424 has a frequency in a range of about 120 kHz to about 140 kHz. As illustrated in FIG. 4, the heating driver signal 424 can have an amplitude that decreases from a first amplitude to a second amplitude over the time axis. In an example, the amplitude of the heating driver signal 424 is in a range of about 120 V_{PP} to about 250 V_{PP}. In some examples, the third amplitude is the first amplitude. In other examples, the amplitude of the heating driver signal 424 is constant. In some examples, a frequency of the heating driver signal 424 can be fixed and the heating driver signal 424 is driven at a resonance of the transducer.

By way of further example, each expulsion sequence 408 to 414 includes a plurality of expulsion driver signals 426 to 432 having signal and timing characteristics that can be applied to the transducer. In an example, the first expulsion driver signal 426 and the third expulsion driver signal 430 are the first and second expulsion driver signals 310, 312, as illustrated in FIG. 3. In further examples, the second expulsion driver signal 428 and the fourth expulsion driver signal 432 are the first and second expulsion driver signals 310, 312, as illustrated in FIG. 3. As such, in some examples, at least some of the plurality of expulsion driver signals 426 to 432 have signal and timing characteristics, as described herein, such as similar to the first or the second expulsion driver signals 310, 312, as illustrated in FIG. 3. The ULC system can be configured to generate each expulsion sequence 408 to 414 based on sequence parameters associated with each sequence 408 to 414. Thus, each of the expulsion driver signals 426 to 432 can be generated for a given expulsion sequence 408 to 414 based on respective sequence parameters associated with the given expulsion sequence 408 to 414. In some examples, the ULC system 102 is configured to generate the plurality of expulsion driver signals 426 to 432 for a given expulsion sequence 408 to 414, such that each of the expulsion driver signals are separated in time from one another. The amount of time between the generation of each expulsion driver signal 426 to 432 to the next can be based on the sequence parameters associated with the given expulsion sequence 408 to 414.

In additional or alternative examples, a subset of the plurality of expulsion driver signals 426 to 432 has a first sweep frequency range, and another subset of the plurality of expulsion driver signals 426 to 432 has a second sweep frequency range. The first sweep frequency range may include frequencies in a given resonance frequency region of a plurality of resonance frequency region of the transducer. The second sweep frequency range may include frequencies in a same or another resonance frequency region of the plurality of resonance frequency regions of the transducer. In some examples, the given resonance frequency region is a higher frequency region of the transducer than the other resonance frequency region.

In further examples, each of the expulsion driver signals 426 to 432 has a first amplitude (e.g., a decreasing amplitude over its on-time over the time axis) or a second amplitude (e.g., an increasing amplitude over its on-time over the time axis). The first amplitude can be greater than the second amplitude. In other examples, the second amplitude is greater than the first amplitude. In some examples, the expulsion driver signals 426 to 432 have different signal widths (e.g., an activation time period). In other examples, the expulsion driver signals 426 to 432 have the same or similar signal widths. In even further examples, the subset of the expulsion driver signals 426 to 432 have a given signal width while the other subset of the dehydration driver signals 426 to 432 have another signal width.

Accordingly, the ULC system 102 can be configured to apply the dehydration sequence, the drying sequencing, and the expulsion sequence to the transducer to excite the transducer and vibrate the top cover. In this way, solid materials (e.g., soil) on the surface of the top cover can be removed without excessive heating of the transducer. Additionally, an operating life of the transducer may be extended as well as the optical protection apparatus in which the transducer is disposed.

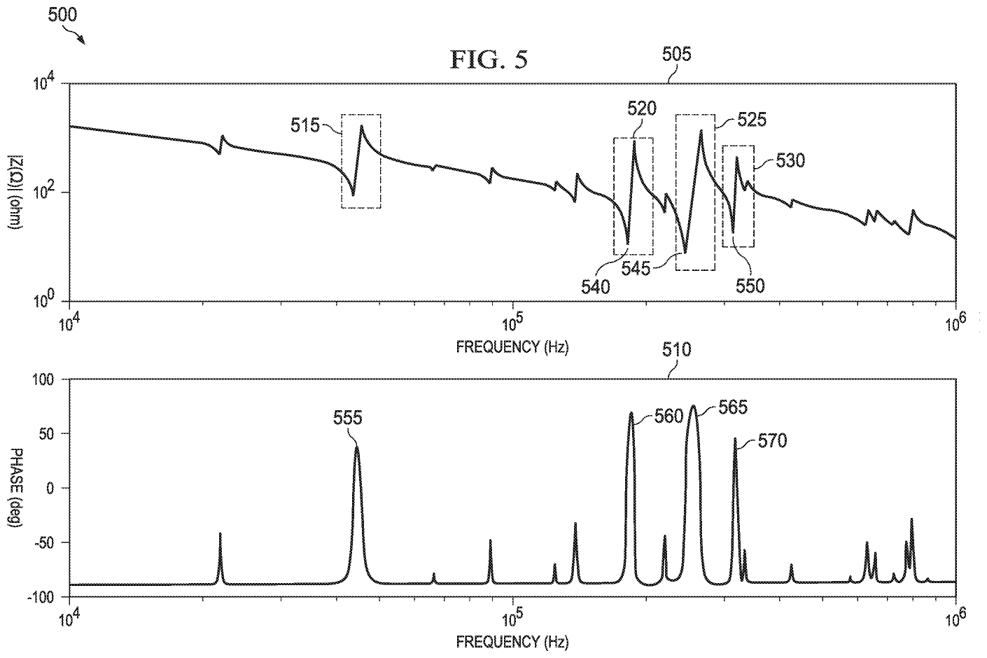

FIG. 5 illustrates an example of a waveform diagram 500 of an impedance response including a magnitude response 505 and phase response 510 for impedance over a broad frequency range for an ULC system. As illustrated in the example of FIG. 5, a y-axis of the magnitude response 505 represents an impedance in ohms (Ω) and an x-axis of the magnitude response 505 represents a frequency in Hertz (Hz), and a y-axis of the phase response 510 represents a phase in degrees (°) and an x-axis of the phase response 510 represents a frequency in Hertz (Hz). The example ULC system can correspond to the optical protection apparatus 200, as illustrated in FIG. 2. The impedance response 510 illustrates the impedance over a frequency range between about 10 kilohertz (kHz) to about 1 megahertz (MHz). The phase response 510 illustrates the phase over the frequency range between about 10 kHz to about 1 MHz.

The “zeros” of the magnitude response 505 can correspond to series resonance properties, which can correspond to electromechanical vibration properties (e.g., such as resonance) of the example ULC system. The electromechanical resonances of the example ULC system can occur at frequencies in which relatively larger vibration amplitudes occur for a variable electrical input amplitude stimulus. For example, electromechanical resonances can occur at frequency ranges 515, 520, 525 and 530. The zeros are indicated by valleys 535, 540, 545 and 550 in the curve 505. As illustrated by the phase response 510, each valley has an associated phase response 555, 560, 565 and 570 in the curve 510 for a given input amplitude.

By way of example, an ultrasonic lens cleaning (ULC) system, such as the ULC system 102, as illustrated in FIG. 1, can be configured to apply sequences having transducer drive signals (e.g., the transducer driver signal 106, as illustrated in FIG. 1) having a frequency or a range of frequencies corresponding to a sweep frequency range that is within a given resonance frequency region, such as the frequency ranges 515-530. Accordingly, the ULC system can be configured to apply sequences with transducer driver signaling having frequencies, such as around or at each valley 535-550, within a given resonance frequency region of the ULC system to excite the transducer and vibrate a top cover to remove contaminants, such as liquid and physical materials from a surface of the top cover.

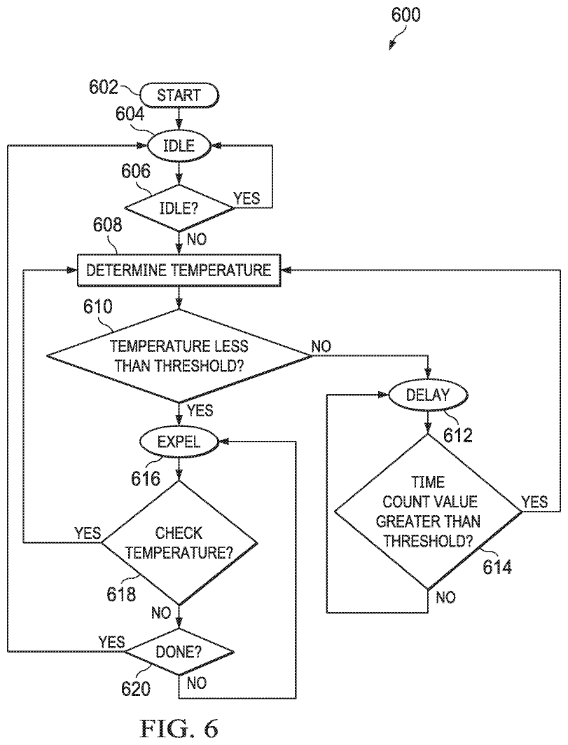

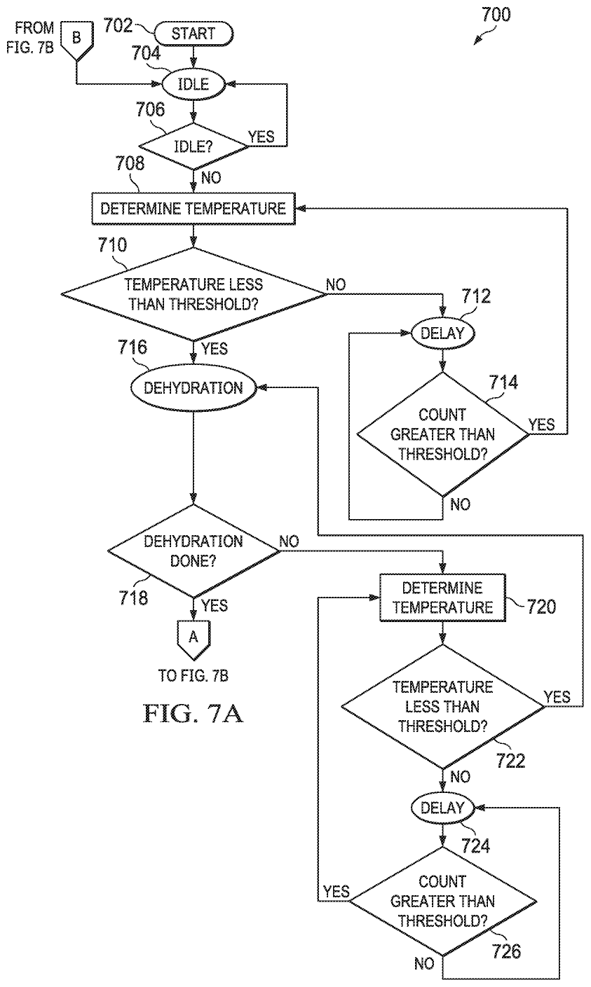

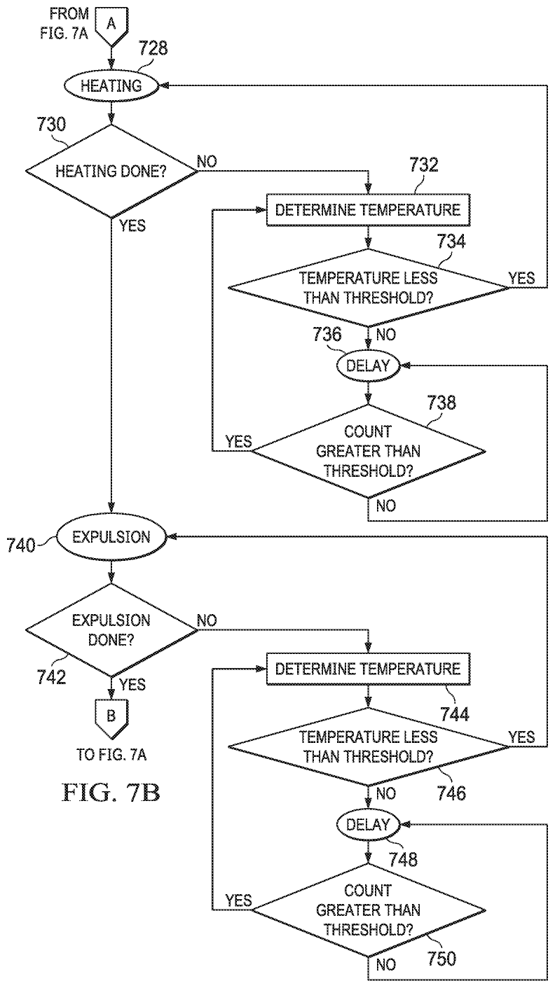

In view of the foregoing structural and functional features described above, example methods will be better appreciated with references to FIGS. 6-7. While, for purposes of simplicity of explanation, the example method of FIGS. 6-7 are shown and described as executing serially, it is to be understood and appreciated that the example method is not limited by the illustrated order, as some actions could in other examples occur in different orders, multiple times and/or concurrently from that shown and described herein.

FIG. 6 illustrates an example of a method 600 for cleaning contaminants from a top cover of an optical protection apparatus. The optical protection apparatus can correspond to the optical protection apparatus, as illustrated in FIG. 2. The method 600 can be implemented by an ultrasonic lens cleaning (ULC) system, such as the ULC system 102, as illustrated in FIG. 1. As such, at least a portion of the method 600 can be implemented as coded instructions (e.g., computer and/or machine readable instructions) that can be representative of a lens cleaning application that can be implemented by the controller 108 of the ULC system 102.

The method 600 begins at 602 by the ULC system being initiated (representative by the “START” block element in FIG. 6). For example, the ULC system may start in response to application of power to the ULC system by a power supply. At 604, the ULC system is configured to idle (e.g., wait) for a mode signal. For example, the ULC system may be configured to enter a first operating mode in response to receiving a mode signal indicative that the ULC system is to function in the first operating mode. The mode signal can correspond to the mode signal 114, as illustrated in FIG. 1. In other examples, the ULC system is configured to enter the first operating mode directly upon being initiated at 602. At 606, a determination can be made whether the ULC system is to idle. If the ULC system is to idle (representative as a “YES” in FIG. 6), the process can loop back to 604 and the ULC system can be configured to continue to idle (e.g., function in the first operating mode), such as for a given amount of time.

If the determination at 606 indicates that the ULC system is not to idle (representative as a “NO” in FIG. 6), the method can proceed to 608 (e.g., and the ULC system can function in a second operating mode). In some examples, the determination at 606 can be based on the mode signal (e.g., providing an indication that the ULC system is to function in the second operating mode). At 608, the ULC system can be configured to determine (e.g., estimate) the temperature of the transducer, such as described herein or in a same or similar manner as described in the '569 patent application. The transducer can correspond to the transducer 104, as illustrated in FIG. 1 or the transducer 208, as illustrated in FIG. 2.

At 610, the ULC system can be configured to determine if the temperature of the transducer is less than a temperature threshold. In response to determining that the temperature is less than the temperature threshold, the process can proceed to 616 (representative as “YES” in FIG. 6). In response to determining that the temperature is not less than the temperature threshold, the process can proceed to 612 (representative as “NO” in FIG. 6). At 612, the ULC system can be configured to delay application of an expulsion sequence to the transducer for a given amount of time based on a time count value for a timer. The expulsion sequence when applied to the transducer can excite the transducer and cause the top cover coupled to the transducer to vibrate to expel at least a portion of the liquid material (e.g., water) from the surface of the top cover.

At 614, the ULC system can be configured to determine if the time count value is greater than (or equal to) the count threshold. If the time count value is not greater than (or equal to) the count threshold, the process can loop back to 612 (representative as a “NO” in FIG. 6). If the time count value is greater than (or equal to) the count threshold, the process can proceed to 608 (representative as a “YES” in FIG. 6). At 608, the ULC system can be configured to determine (e.g., estimate) the temperature of the transducer. In response to determining that the temperature is less than the temperature threshold, the process can proceed to 616 (representative as “YES” in FIG. 6). At 616, the ULC system can be configured to apply the expulsion sequence to the transducer to excite the transducer and expel at least the portion of the liquid material from the surface of the top cover. In some examples, the expulsion sequence can correspond to a given expulsion sequence, such as one of the expulsion sequences 302 to 308, as illustrated in FIG. 3.

At 618, the ULC system can be configured to determine if the temperature of the transducer needs to be checked. If the temperature of the transducer needs to be checked (e.g., determined), the method can loop back to 608 (representative as a “YES” in FIG. 6) and the temperature of the transducer can be determined in a same or similar manner as described herein. If the temperature of the transducer does not need to be checked (e.g., determined), the method can proceed to 620 (representative as a “YES” in FIG. 6).

At 620, the ULC system can be configured to determine whether the ULC system is done applying expulsion sequences to the transducer. The ULC system can be configured to determine whether a subsequent expulsion sequence is to be applied to the transducer by evaluating a number of expulsion sequence that have been applied to the transducer. If it is determined that ULC system is not done applying expulsion sequences to the transducer, the process can loop back (representative as a “NO” in FIG. 6) to 616, and the ULC system can be configured to apply another expulsion sequence to the transducer. For example, if the number of applied expulsion sequences is less than an expulsion sequence count threshold, the ULC system can be configured to apply the other expulsion sequence to the transducer. At 616, the ULC system can be configured to apply the other expulsion sequence to the transducer, such that the top cover vibrates and a remaining portion of the liquid material that was not removed by at least one prior expulsion sequence is expelled from the top cover. If the number of applied expulsion sequences is equal to the expulsion sequence count threshold, the process can loop back to 604 (representative as a “YES” in FIG. 6).

Accordingly, by implementing the method 600, the ULC system can be configured to apply the expulsion sequence to the transducer to excite the transducer and vibrate the lens in a continuous manner, such that liquid materials (e.g., water) on the surface of the top cover can be efficiently removed (e.g., during heavy rain conditions) without excessive heating of the transducer, thereby extending an operating life of the transducer and thus the optical protection apparatus in which the transducer is disposed.

FIGS. 7A-7B illustrates an example of a method 700 for cleaning contaminants from a top cover of an optical protection apparatus. The optical protection apparatus can correspond to the optical protection apparatus, as illustrated in FIG. 2. The method 700 can be implemented by an ultrasonic lens cleaning (ULC) system, such as the ULC system 102, as illustrated in FIG. 1. As such, at least a portion of the method 700 can be implemented as coded instructions (e.g., computer and/or machine readable instructions) that can be representative of a lens cleaning application that can be implemented by the controller 108 of the ULC system 102.

The method 700 begins at 702 by the ULC system being initiated (representative by the “START” block element in FIG. 7A). For example, the ULC system may start in response to application of power to the ULC system by a power supply. At 704, the ULC system is configured to idle (e.g., wait) for a mode signal. For example, the ULC system may be configured to enter a first operating mode in response to receiving a mode signal indicative that the ULC system is to function in the first operating mode. The mode signal can correspond to the mode signal 114, as illustrated in FIG. 1. In other examples, the ULC system is configured to enter the first operating mode directly upon being initiated at 702. At 706, a determination can be made whether the ULC system is to idle. If the ULC system is to idle (representative as a “YES” in FIG. 7A), the process can loop back to 704 and the ULC system can be configured to continue to idle (e.g., function in the first operating mode), such as for a given amount of time.

If the determination at 706 indicates that the ULC system is not to idle (representative as a “NO” in FIG. 7A), the method can proceed to 708 (e.g., and the ULC system can function in a third operating mode). In some examples, the determination at 706 can be based on the mode signal (e.g., providing an indication that the ULC system is to function in the third operating mode). At 708, the ULC system can be configured to determine (e.g., estimate) the temperature of the transducer, such as described herein or in a same or similar manner as described in the '569 patent application. The transducer can correspond to the transducer 104, as illustrated in FIG. 1 or the transducer 208, as illustrated in FIG. 2.

At 710, the ULC system can be configured to determine if the temperature of the transducer is less than a temperature threshold. In response to determining that the temperature is less than the temperature threshold, the process can proceed to 716 (representative as “YES” in FIG. 7A). In response to determining that the temperature is not less than the temperature threshold, the process can proceed to 712 (representative as “NO” in FIG. 7A). At 712, the ULC system can be configured to delay application of a dehydration sequence to the transducer for given amount of time based on a time count value of a timer.

At 714, the ULC system can be configured to determine if the time count value is greater than (or equal to) the count threshold. If the time count value is greater than (or equal to) the count threshold, the process can loop back to 712 (representative as a “NO” in FIG. 7A). If the time count value is greater than (or equal to) the count threshold at 714, the process can proceed to 708 (representative as a “YES” in FIG. 7A) to determine the temperature of the transducer. If the temperature of the transducer is below the temperature threshold at 710, the process can proceed to 716 (representative as “YES” in FIG. 7A). At 716, the ULC system can be configured to apply the dehydration sequence to the transducer to excite the transducer. Resultantly, the top cover coupled to the transducer can vibrate, such that the solid material on the surface of the top cover is at least partially dehydrated the solid material. In some examples, the dehydration sequence is the dehydration sequence 402 or the dehydration sequence 404, as illustrated in FIG. 4.

At 718, the ULC system can be configured to determine whether the ULC system is done applying dehydration sequences to the transducer. The ULC system may be configured to determine whether a subsequent dehydration sequence is to be applied to the transducer by evaluating a number of dehydration sequences that have been applied to the transducer relative to a dehydration sequence count threshold. If it is determined that the ULC system is not done applying dehydration sequences to the transducer, the process can proceed to 720 (representative as a “NO” in FIG. 7A). For example, if the number of applied dehydration sequences is less than the dehydration sequence count threshold, the process can proceed to 720. If the number of applied dehydration sequences is equal to the dehydration sequence count threshold, the process can proceed to 728.

At 720, the ULC system can be configured to determine (e.g., estimate) the temperature of the transducer. At 722, the ULC system can be configured to determine if the temperature of the transducer is less than a temperature threshold. In response to determining that the temperature is less than the temperature threshold, the process can proceed to 716 (representative as “YES” in FIG. 7A). In response to determining that the temperature is not less than the temperature threshold, the process can proceed to 724 (representative as “NO” in FIG. 7A). At 724, the ULC system can be configured to delay application of a dehydration sequence to the transducer for given amount of time based on the time count value of the timer. At 726, the ULC system can be configured to determine if the time count value is greater than (or equal to) the count threshold. If the time count value is greater than (or equal to) the count threshold, the process can loop back to 724 (representative as a “NO” in FIG. 7A). If the time count value is greater than (or equal to) the count threshold at 726, the process can proceed to 720 (representative as a “YES” in FIG. 7A) to determine the temperature of the transducer. If the temperature of the transducer is below the temperature threshold at 722, the process can proceed to 716 (representative as “YES” in FIG. 7A). At 716, the ULC system can be configured to apply the subsequent dehydration sequence to the transducer to vibrate the top cover. Resultantly, the top cover coupled to the transducer can vibrate and further dehydrate the solid material.

At 718, the ULC system can be configured to determine whether the ULC system is done applying dehydration sequences to the transducer. If the number of applied dehydration sequences is equal to the dehydration sequence count threshold, the process can proceed to 728 (representative as “YES” in FIG. 7A). At 728, the ULC system can be configured to apply a heating sequence to the transducer to vibrate the top cover to at least partially heat the dehydrated solid material on the top cover. In some examples, the heating sequence can correspond to the heating sequence 406, as illustrated in FIG. 4.

At 730, the ULC system can be configured to determine whether the ULC system is done applying heating sequences to the transducer. The ULC system may be configured to determine whether a subsequent heating sequence is to be applied to the transducer by evaluating a number of heating sequences that have been applied to the transducer relative to a heating sequence count threshold. If it is determined that ULC system is not done applying heating sequences to the transducer, the process can proceed to 732 (representative as a “NO” in FIG. 7B). For example, if the number of applied heating sequences is less than the heating sequence count threshold, the process can proceed to 732. If the number of applied heating sequences is equal to the heating sequence count threshold, the process can proceed to 740.

At 732, the ULC system can be configured to determine (e.g., estimate) the temperature of the transducer. At 734, the ULC system can be configured to determine if the temperature of the transducer is less than a temperature threshold. In response to determining that the temperature is less than the temperature threshold, the process can proceed to 728 (representative as “YES” in FIG. 7B). In response to determining that the temperature is not less than the temperature threshold, the process can proceed to 736 (representative as “NO” in FIG. 7B). At 736, the ULC system can be configured to delay application of a dehydration sequence to the transducer for given amount of time based on the time count value of the timer. At 738, the ULC system can be configured to determine if the time count value is greater than (or equal to) the count threshold. If the time count value is greater than (or equal to) the count threshold, the process can loop back to 736 (representative as a “NO” in FIG. 7B). If the time count value is greater than (or equal to) the count threshold at 738, the process can proceed to 732 (representative as a “YES” in FIG. 7B) to determine the temperature of the transducer. If the temperature of the transducer is below the temperature threshold at 734, the process can proceed to 728 (representative as “YES” in FIG. 7B). At 728, the ULC system can be configured to apply the subsequent heating sequence to the transducer to vibrate the top cover. Resultantly, the top cover coupled to the transducer can excite and further heat the dehydrated solid material on the top cover.

At 730, the ULC system can be configured to determine whether the ULC system is done applying heating sequences to the transducer. If the number of applied heating sequences is equal to the heating sequence count threshold, the process can proceed to 740 (representative as “YES” in FIG. 7B). At 740, the ULC system can be configured to apply an expulsion sequence to the transducer to vibrate the top cover to expel at least a portion of the heated and dehydrated solid material on the top cover. In some examples, the expulsion sequence is the expulsion sequence 302, as illustrated in FIG. 3, or the expulsion sequence 406, as illustrated in FIG. 4.

At 742, the ULC system can be configured to determine whether the ULC system is done applying expulsion sequences to the transducer. The ULC system may be configured to determine whether a subsequent expulsion sequence is to be applied to the transducer by evaluating a number of expulsion sequences that have been applied to the transducer relative to an expulsion sequence count threshold. If it is determined that ULC system is not done applying expulsion sequences to the transducer, the process can proceed to 744 (representative as a “NO” in FIG. 7B). For example, if the number of applied expulsion sequences is less than the expulsion sequence count threshold, the process can proceed to 744.

At 744, the ULC system can be configured to determine (e.g., estimate) the temperature of the transducer. At 746, the ULC system can be configured to determine if the temperature of the transducer is less than a temperature threshold. In response to determining that the temperature is less than the temperature threshold, the process can proceed to 740 (representative as “YES” in FIG. 7B). In response to determining that the temperature is not less than the temperature threshold, the process can proceed to 748 (representative as “NO” in FIG. 7B). At 748, the ULC system can be configured to delay application of a dehydration sequence to the transducer for given amount of time based on the time count value of the timer. At 750, the ULC system can be configured to determine if the time count value is greater than (or equal to) the count threshold. If the time count value is greater than (or equal to) the count threshold, the process can loop back to 748 (representative as a “NO” in FIG. 7B). If the time count value is greater than (or equal to) the count threshold at 750, the process can proceed to 744 (representative as a “YES” in FIG. 7B) to determine the temperature of the transducer. If the temperature of the transducer is below the temperature threshold at 746, the process can proceed to 740 (representative as “YES” in FIG. 7B).

At 740 the ULC system can be configured to apply the subsequent expulsion sequence to the transducer to vibrate the top cover to expel a further portion of the dried and dehydrated solid material on the top cover. At 742, the ULC system can be configured to determine whether the ULC system is done applying expulsion sequences to the transducer. If the number of applied expulsion sequences is equal to the expulsion sequence count threshold, the process can loop back to 704 (representative as a “YES” in FIG. 7B).

Accordingly, by implementing the method 700, the ULC system can be configured to apply the dehydration sequence, drying sequencing, and expulsion sequence to the transducer to selectively excite the transducer and vibrate the top cover, such that solid materials (e.g., soil) on the surface of the top cover can be removed without excessive heating of the transducer, thereby extending an operating life of the transducer and thus the optical protection apparatus in which the transducer is disposed.

In this description and the claims, the term “based on” means based at least in part on.

Modifications are possible in the described embodiments, and other embodiments are possible, within the scope of the claims.

What is claimed is:

1. A method comprising:
applying sequences of at least one driver signal adapted to drive a transducer adaptively coupled to a top cover, the transducer being excited based on the sequences to vibrate the top cover to remove a contaminant from a surface of the top cover, wherein the applying the sequences comprises:
applying a first sequence to the transducer based on a first set of sequence parameters;
applying a second sequence to the transducer based on a second set of sequence parameters; and
applying a third sequence to the transducer based on a third set of sequence parameters.

2. The method of claim 1, wherein the first sequence is a dehydration sequence, the dehydration sequence being applied to the transducer to vibrate the top cover to at least partially dehydrate the contaminant.

3. The method of claim 2, wherein the applying the dehydration sequence to the transducer comprises:
generating driver signals with respective amplitudes and frequencies based on the first set of sequence parameters; and
providing the driver signals to the transducer to vibrate the top cover to at least partially dehydrate the contaminant.

4. The method of claim 2, wherein the second sequence is a heating sequence, the heating sequence being applied to the transducer to vibrate the top cover to at least partially heat the contaminant in response to applying the dehydration sequence to the transducer.

5. The method of claim 4, wherein the applying the heating sequence to the transducer comprises:
generating a driver signal with an amplitude and a frequency based on the second set of sequence parameters; and
applying the driver signal to vibrate the top cover to at least partially dry the contaminant.

6. The method of claim 4, wherein the third sequence is an expulsion sequence, the expulsion sequence being applied to the transducer to vibrate the top cover to expel at least a portion of the contaminant from the top cover in response to applying the heating sequence to the transducer.

7. The method of claim 6, wherein the applying the expulsion sequence to the transducer comprises:
generating driver signals with respective amplitudes and frequencies based on the third set of sequence parameters; and
applying the driver signals to vibrate the top cover to expel at least the portion of the contaminant from the top cover.

8. The method of claim 1, wherein:
the first sequence comprises first driver signals having signal and timing characteristics based on the first set of sequence parameters;
the second sequence comprises a second driver signal having signal and timing characteristics based on the second set of sequence parameters; and
the third sequence comprises third driver signals having signal and timing characteristics based on the third set of sequence parameters.

9. The method of claim 8, wherein the first driver signals are first sweep signals, the first sweep signals being generating by sweeping each of the first driver signals over a predetermined frequency range.

10. The method of claim 9, wherein:
the first driver signals comprise first and second dehydration driver signals;
the first dehydration driver signal has an amplitude that one of decreases or increases from a first amplitude to a second amplitude or is constant as the first dehydration driver signal is being swept over the predetermined frequency range over a first period of time; and
the second dehydration driver signal has an amplitude that one of decreases or increases from a third amplitude to a fourth amplitude or is constant as the second dehydration driver signal is being swept over the predetermined frequency range over a second period of time.

11. The method of claim 10, wherein the second driver signal is a heating driver signal and corresponds to a second sweep signal, the second sweep signal being generated by sweeping the heating driver signal over the predetermined frequency range, wherein the heating driver signal has an amplitude that one of increases or decreases from a fifth amplitude to a sixth amplitude or is constant as the heating driver signal is being swept over the predetermined frequency range over a third period of time.

12. The method of claim 11, wherein the third driver signals are third sweep signals, the third sweep signals being generating by sweeping each of the third driver signals over the predetermined frequency range.

13. The method of claim 12, wherein:
the third driver signals comprise a first, a second, a third, and a fourth expulsion driver signal;
the first expulsion driver signal has an amplitude that one of increases or decreases from a seventh amplitude to an eighth amplitude or is constant as the first expulsion driver signal is being swept over the predetermined frequency range over a fourth period of time;
the second expulsion driver signal has an amplitude that one of increases or decreases from the seventh amplitude to the eighth amplitude or is constant as the second expulsion driver signal is being swept over the predetermined frequency range over a fifth period of time;
the third expulsion driver signal has an amplitude that one of increases or decreases from a ninth amplitude to a tenth amplitude or is constant as the third expulsion driver signal is being swept over the predetermined frequency range over a sixth period of time; and
the fourth expulsion driver signal has an amplitude that one of increases or decreases from the ninth amplitude to the tenth amplitude or is constant as the fourth expulsion driver signal is being swept over the predetermined frequency range over a seventh period of time.

14. A device comprising:
driver circuitry configured to generate transducer signals at an output; and
a controller comprising memory storing machine readable instructions for controlling the driver circuitry, the machine readable instructions causing the driver circuitry to:
generate first driver signals having signal and timing characteristics based on a first set of sequence parameters;
generate a second driver signal having signal and timing characteristics based on a second set of sequence parameters;
generate third driver signals having signal and timing characteristics based on a third set of sequence parameters, wherein the first, second and third driver signals correspond to the transducer signals and are adapted to drive a transducer to vibrate a top cover to remove a contaminant from a surface of the top cover.

15. The device of claim 14, wherein the first driver signals are associated with a dehydration sequence, the first driver signals being applied to the transducer to vibrate the top cover to at least partially dehydrate the contaminant.

16. The device of claim 15, wherein the second driver signal is associated with a heating sequence, the second driver signal being applied to the transducer to vibrate the top cover to at least partially heat the contaminant.

17. The device of claim 16, wherein the third driver signals are associated with an expulsion sequence, the third driver signals being applied to the transducer to vibrate the top cover to expel at least a portion of the contaminant from the top cover.

18. The device of claim 17, wherein the controller is further configured to before or after each application of a respective driver signal associated with each sequence evaluate a measured temperature of the transducer relative to a given temperature threshold or a given temperature operating range for the transducer, the controller being configured to regulate the generation of the respective driver signal associated with each sequence based on the evaluation.

19. A method comprising:
generating expulsion sequences based on a set of sequence parameters, each expulsion sequence comprising driver signals, the driver signals of each expulsion sequence being separated in time over a given time interval based on a time parameter of the set of sequence parameters; and
applying each of the expulsion sequences by adaptively driving a transducer to vibrate a top cover to remove a contaminant from a surface of the top cover, wherein the application of each expulsion sequence to the transducer vibrates the top cover to remove at least a portion of the contaminant from the top cover.

20. The method of claim 19, wherein:
the driver signals comprise first and second driver signals;
the first driver signal has an amplitude that one of increases or decreases from a first amplitude to a second amplitude or is constant as the first driver signal is being swept over a predetermined frequency range over a first period of time within the given time interval; and
the second driver signal has an amplitude that one of increases or decreases from a third amplitude to a fourth amplitude or is constant as the second driver signal is being swept over the predetermined frequency range over a second period of time within the given time interval.
